(19) United States
(12) Patent Application Publication
(10) Pub. No.: US 2024/0263949 A1
(43) Pub. Date: Aug. 8, 2024

(54) EGOMOTION LOCATION ENHANCEMENT USING SENSED FEATURES MEASUREMENTS

(71) Applicant: Arriver Software AB, Linköping (SE)

(72) Inventor: Martin DAHL, Vikingstad (SE)

(21) Appl. No.: 18/163,463

(22) Filed: Feb. 2, 2023

(51) Int. Cl. G01C 21/30

(52) U.S. Cl. CPC G01C 21/30

(57) ABSTRACT

Systems and methodologies for determining location of a vehicle is provided. The method includes obtaining a first location of the vehicle at a first time. A dead reckoning location of the vehicle is determined at a second time. Additionally, feature information is obtained at the second time. The feature information may be provided by a digital map or database, that includes records for at least some of the vehicle's surrounding objects. These records may include, for example, relative positional attributes in addition to the traditional absolute positions. Location measurements are obtained for one or more features that are identifiable based on the feature information. The dead reckoning location of the vehicle is corrected based on the location measurements.

### TECHNICAL FIELD

The present disclosure relates to determining a location of a vehicle, and more particularly to determining a location of a vehicle based on dead reckoning, and correcting error in the dead reckoning location by using sensed feature measurements.

### BACKGROUND

A vehicle often requires information about its current location as it moves along streets or other terrain. To accomplish this, a vehicle may receive and utilize Global Positioning System (GPS) signals to determine a current position of the vehicle, and in turn use that current position information as input for navigation applications. GPS is an example of a Global Navigation Satellite System (GNSS) navigation system in which a receiver determines its position by precisely measuring the arrival time of signaling events received from multiple satellites. However, GPS signals are not always reliably received by the vehicle. For example, GPS accuracy may degrade significantly under weak signal conditions such as when the line-of-sight (LOS) to the satellite(S) is obstructed by natural or manmade objects, such as tall buildings, mountains or canyons. Depending on the environment, the vehicle may not even receive the GPS signal, or the accuracy of the GPS may result in positional errors in the order of tens of meters (e.g. as much as 50 meters).

Another navigational system that may be employed by a vehicle is known as “dead reckoning.” Distance traveled and the heading of the vehicle is determined using various sensors employed on the vehicle, which is then processed to calculate a position of the vehicle. One issue with Dead Reckoning may be the accuracy of the sensors. The error induced by this lack of accuracy, over long stretches of time, may result in significant error in the distance travelled, or a bias in the heading of the vehicle.

Due to the increasing demands of the automotive industry, future consumer navigational systems will require higher accuracy than that of currently employed systems.

### SUMMARY

A method of determining location of a vehicle according to the disclosure includes obtaining, for example, a first location of the vehicle at a first time. A dead reckoning location of the vehicle is determined at a second time. Additionally, feature information is obtained at the second time. The feature information may be provided by a digital map or database, that includes records for at least some of the vehicle's surrounding objects. These records may include, for example, relative positional attributes in addition to the traditional absolute positions. Location measurements are obtained for one or more features that are identifiable based on the feature information. The dead reckoning location of the vehicle is corrected based on the location measurements.

Implementations of such a method may include one or more of the following features. The first location may be set to the corrected dead reckoning location. A second dead reckoning location of the vehicle may be determined at a third time. Second feature information may be obtained at the third time. Second location measurements for one or more features that are identifiable based on the second feature information may be obtained. The second dead reckoning location of the vehicle may be corrected based on the second location measurements. Obtaining the first location may include obtaining a location computed by a satellite position system. The vehicle may include one or more sensors, such that obtaining location measurements for the one or more features may include obtaining sensor information from the one or more sensors. The one or more sensors may be a LIDAR device, a camera device, a radar device or combinations thereof. The one or more features may include an intersection, a crosswalk, a geographic landmark, a building, width of a road, a road sign, a traffic light, a telephone post. a lamppost or combinations thereof. Obtaining feature information may include obtaining a range and/or bearing of at least one of the one or more features relative to the vehicle. Correcting the dead reckoning location of the vehicle may include triangulation and/or trilateration. Obtaining location measurements for one or more features may include sensor fusion. The method may further include compiling correction data pertaining to the location of the vehicle over time; using statistical bias and/or a neural network to predict error in the dead reckoning; and using the predicted error in dead reckoning to correct a current location of the vehicle.

An example system for determining location of a vehicle according to the disclosure includes a memory, at least one processor communicatively coupled to the memory, and configured to obtain a first location of the vehicle at a first time, determine a dead reckoning location of the vehicle at a second time, obtain feature information at the second time, obtain location measurements for one or more features that are identifiable based on the feature information, and correct the dead reckoning location of the vehicle based on the location measurements.

Implementations of such a system may include one or more of the following features. The at least one processor may be further configured to set the first location to the corrected dead reckoning location, determine a second dead reckoning location of the vehicle at a third time, obtain second feature information at the third time, obtain second location measurements for one or more features that are identifiable based on the second feature information, and correct the second dead reckoning location of the vehicle based on the second location measurements. The at least one processor may be configured to obtain the first location utilizing, in part, a location computed by a satellite position system. The vehicle may include one or more sensors, and the at least one processor may be configured to obtain the first location utilizing sensor information from the one or more sensors. The one or more sensors may include a LIDAR device, a camera device, a radar device or combinations thereof. The one or more features may be an intersection, a crosswalk, a geographic landmark, a building, width of a road, a road sign, a traffic light, a telephone post, a lamppost or combinations thereof. The at least one processor may be configured to obtain feature information including a range and/or bearing of at least one of the one or more features relative to the vehicle. The at least one processor may be configured to correct the dead reckoning location using, at least in part, triangulation and/or trilateration. The at least one processor may be configured to obtain location measurements for one or more features using, at least in part, sensor fusion. The at least one processor may be further configured to: compile correction data pertaining to the location of the vehicle over time; use statistical bias and/or a neural network to predict error in the dead reckoning; and use the predicted error in dead reckoning to correct a current location of the vehicle.

An example system for determining location of a vehicle according to the disclosure includes means for obtaining a first location of the vehicle at a first time; means for determining a dead reckoning location of the vehicle at a second time; means for obtaining feature information at the second time; means for obtaining location measurements for one or more features that are identifiable based on the feature information; and means for correcting the dead reckoning location of the vehicle based on the location measurements.

Implementations of such a system may include one or more of the following features. The system may further include means for setting the first location to the corrected dead reckoning location; means for determining a second dead reckoning location of the vehicle at a third time; means for obtaining second feature information at the third time; means for obtaining second location measurements for one or more features that are identifiable based on the second feature information; and means for correcting the second dead reckoning location of the vehicle based on the second location measurements. The means for obtaining the first location may include obtaining a location computed by a satellite position system. The vehicle may include one or more sensors, and obtaining location measurements for the one or more features includes means for obtaining sensor information from the one or more sensors. The sensors may include using a LIDAR device, a camera device, a radar device or combinations thereof. The one or more features may include an intersection, a crosswalk, a geographic landmark, a building, width of a road, a road sign, a traffic light, a telephone post, a lamppost or combinations thereof. The means for obtaining feature information may include obtaining a range and/or bearing of at least one of the one or more features relative to the vehicle. The means for correcting the dead reckoning position of the vehicle may include triangulation and/or trilateration. The means for obtaining location measurements for one or more features may include sensor fusion. The system may further include means for compiling correction data pertaining to the location of the vehicle over time; means for using statistical bias and/or a neural network to predict error in the dead reckoning; and means for using the predicted error in dead reckoning to correct a current location of the vehicle.

An example non-transitory processor-readable storage medium according to the disclosure includes processor-readable instructions configured to cause one or more processors to determine a location of a vehicle. The non-transitory processor-readable storage medium may includes code for obtaining a first location of the vehicle at a first time; code for determining a dead reckoning location of the vehicle at a second time; code for obtaining feature information at the second time; code for obtaining location measurements for one or more features that are identifiable based on the feature information; and code for correcting the dead reckoning location of the vehicle based on the location measurements.

Implementations of such a storage medium may include one or more of the following features. The non-transitory processor-readable storage medium may include code for setting the first location to the corrected dead reckoning location; code for determining a second dead reckoning location of the vehicle at a third time; code for obtaining second feature information at the third time; code for obtaining second location measurements for one or more features that are identifiable based on the second feature information; and code for correcting the second dead reckoning location of the vehicle based on the second location measurements. The non-transitory processor-readable storage medium may include code for obtaining a location computed by a satellite position system. The vehicle may include one or more sensors, and the code for obtaining location measurements for the one or more features may include code for obtaining sensor information from the one or more sensors. The one or more sensors may include a LIDAR device, a camera device, a radar device or combinations thereof. The one or more features may include an intersection, a crosswalk, a geographic landmark, a building, a width of a road, a road sign, a traffic light, a telephone post, a lamppost or combinations thereof. The code for obtaining feature information may further include code for obtaining a range and/or bearing of at least one of the one or more features relative to the vehicle. The code for correcting the dead reckoning position of the vehicle may include code for performing triangulation and/or trilateration. The code for obtaining location measurements for one or more features may include code for performing sensor fusion. The non-transitory processor-readable storage medium may further include code for compiling correction data pertaining to the location of the vehicle over time; code for using statistical bias and/or a neural network to predict error in the dead reckoning; and code for using the predicted error in dead reckoning to correct a current location of the vehicle.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 illustrates a block diagram of example components and/or systems implemented in a vehicle.

FIG. 2 illustrates a view of an example vehicle configured with various sensor and communications components and/or systems.

FIG. 3 is a functional block level diagram of an example vehicle.

FIG. 4 is a process flow diagram of an example method for providing correction of a dead reckoning location of a vehicle.

FIG. 5 is a diagram of example errors that may result when performing dead reckoning (DR), and corrections thereof.

FIG. 6 is a diagram of example triangulation based on feature location measurements to determine location of a vehicle.

FIG. 7 is an example of map and sensor information fusion.

### DETAILED DESCRIPTION

Techniques for determining a location of a vehicle are provided. Dead reckoning may be used to determine a location of the vehicle. Error in the dead reckoning location may be corrected by using location measurements of features that are identifiable in the surrounding area. These techniques and configurations are examples, and other configurations and techniques may be used.

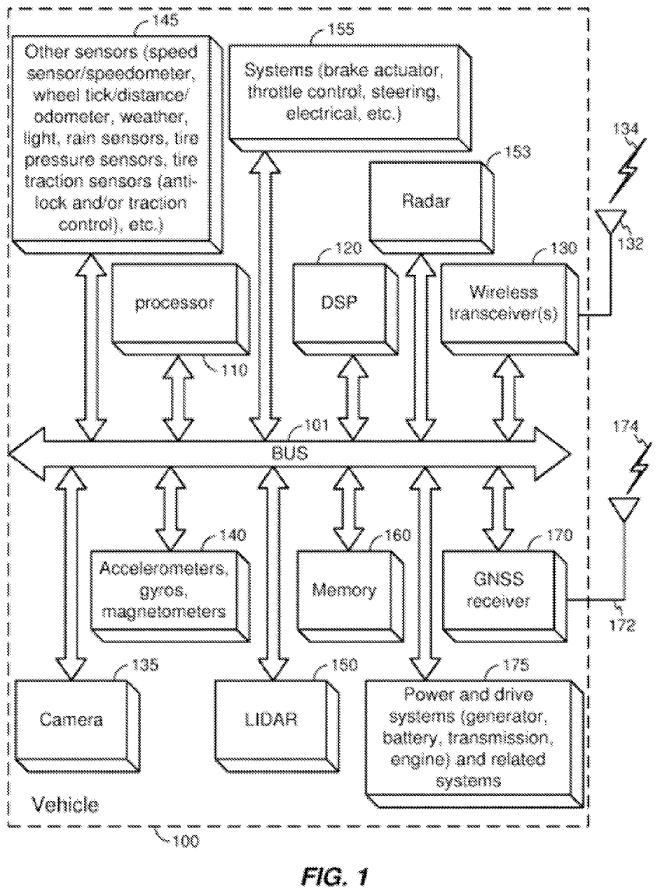

FIG. 1 is a block diagram of various components and/or systems implemented in an exemple vehicle, such as a car. The vehicle 100 may include one or more cameras 135. The camera may comprise a camera sensor and mounting assembly. Different mounting assemblies may be used for different cameras on vehicle 100. For example, front facing cameras may be mounted in the front bumper, in the stem of the rear-view mirror assembly or in other front facing areas of the vehicle 100. Rear facing cameras may be mounted in the rear bumper/fender, on the rear windshield, on the trunk or other rear facing areas of the vehicle. The side facing mirrors may be mounted on the side of the vehicle such as being integrated into the mirror assembly or door assemblies. The cameras may provide object detection and distance estimation, particularly for objects of known size and/or shape (e.g., a stop sign and a license plate both have standardized size and shape) and may also provide information regarding rotational motion relative to the axis of the vehicle such as during a turn. When used in concert with the other sensors, the cameras may both be calibrated through the use of other systems such as through the use of LIDAR, wheel tick/distance sensors, and/or GNSS to verify distance traveled and angular orientation. The cameras may similarly be used to verify and calibrate the other systems to verify that distance measurements are correct, for example by calibrating against known distances between known objects (landmarks, roadside markers, road mile markers, etc.) and also to verify that object detection is performed accurately such that objects are accordingly mapped to the correct locations relative to the car by LIDAR and other systems. Similarly, when combined with, for example, accelerometers, impact time with road hazards, may be estimated (elapsed time before hitting a pot hole for example) which may be verified against actual time of impact and/or verified against stopping models (for example, compared against the estimated stopping distance if attempting to stop before hitting an object) and/or maneuvering models (verifying whether current estimates for turning radius at current speed and/or a measure of maneuverability at current speed are accurate in the current conditions and modifying accordingly to update estimated parameters based on camera and other sensor measurements).

Accelerometers, gyros and magnetometers 140 may be utilized to provide and/or verify motion and directional information. Accelerometers and gyros may be utilized to monitor wheel and drive train performance. Accelerometers, may also be utilized to verify actual time of impact with road hazards such as potholes relative to predicted times based on existing stopping and acceleration models as well as steering models. Gyros and magnetometers may in an embodiment, be utilized to measure rotational status of the vehicle as well as orientation relative to magnetic north, respectively, and to measure and calibrate estimates and/or models for turning radius at current speed and/or a measure of maneuverability at current speed, particularly when used in concert with measurements from other external and internal sensors such as other sensors 145 such as speed sensors, wheel tick sensors, and/or odometer measurements.

The light detection and ranging (LIDAR) 150 subsystem uses pulsed laser light to measure ranges to objects. While cameras may be used for object detection, LIDAR 150 provides a means, to detect the distances (and orientations) of the objects with more certainty, especially in regard to objects of unknown size and shape. LIDAR 150 measurements may also be used to estimate rate of travel, vector directions, relative position and stopping distance by providing accurate distance measurements and delta distance measurements.

Memory 160 may be utilized with processor 110 and/or DSP 120. which may comprise FLASH, RAM, ROM, disc drive, or FLASH card or other memory devices or various combinations thereof. In an embodiment, memory 160 may contain instructions to implement various methods described throughout this description including, for example, processes to implement the use of relative positioning between vehicles and between vehicles and external reference objects such as roadside units. In an embodiment, memory may contain instructions for operating and calibrating sensors, and for receiving map, weather, vehicular (both vehicle 100 and surrounding vehicles) and other data, and utilizing various internal and external sensor measurements and received data and measurements to determine driving parameters such as relative position, absolute position, stopping distance, acceleration and turning radius at current speed and/or maneuverability at current speed, inter-car distance, turn initiation/timing and performance, and initiation/timing of driving operations.

Power and drive systems (generator, battery, transmission, engine) and related systems 175 and systems (brake, actuator, throttle control, steering, and electrical) 155 may be controlled by the processor(s) and/or hardware or software or by an operator of the vehicle or by some combination thereof. The systems (brake, actuator, throttle control, steering, electrical, etc.) 155 and power and drive or other systems 175 may be utilized in conjunction with performance parameters and operational parameters, to enable autonomously (and manually, relative to alerts and emergency overrides/braking/stopping) driving and operating a vehicle 100 safely and accurately, such as to safely, effectively and efficiently merge into traffic, stop, accelerate and otherwise operate the vehicle 100. Input from the various sensor systems such as camera 135, accelerometers, gyros and magnetometers 140, LIDAR 150, GNSS receiver 170, RADAR 153, input, messaging and/or measurements from wireless transceiver(s) 130 and/or other sensors 145 or various combinations thereof, may be utilized by processor 110 and/or DSP 120 or other processing systems to control power and drive systems 175 and systems (brake actuator, throttle control, steering, electrical, etc.) 155.

A global navigation satellite system (GNSS) receiver may be utilized to determine position relative to the earth (absolute position) and, when used with other information such as measurements from other objects and/or mapping data, to determine position relative to other objects such as relative to other cars and/or relative to the road surface.

GNSS receiver 170 may support one or more GNSS constellations as well as other satellite-based navigation systems. For example, GNSS receiver 170 may support global navigation satellite systems such as the Global Positioning System (GPS), the Global'naya Navigatsionnaya Sputnikovaya Sistema (GLONASS), Galileo, and/or BeiDou, or any combination thereof. In an embodiment, GNSS receiver 170 may support regional navigation satellite systems such as NAVIC or QZSS or combination thereof as well as various augmentation systems (e.g., satellite based augmentation systems (SBAS) or ground based augmentation systems (GBAS)) such as doppler orbitography and radio-positioning integrated by satellite (DORIS) or wide area augmentation system (WAAS) or the European geostationary navigation overlay service (EGNOS) or the multi-functional satellite augmentation system (MSAS) or the local area augmentation system (LAAS). In an embodiment, GNSS receiver(s) 130 and antenna(s) 132 may support multiple bands and sub-bands such as GPS L1, L2 and L5 bands, Galileo E1, E5, and E6 bands, Compass (BeiDou) B1, B3 and B2 bands, GLONASS G1, G2 and G3 bands, and QZSS L1C, L2C and L5-Q bands.

The GNSS receiver 170 may be used to determine location and relative location which may be utilized for location, navigation, and to calibrate other sensors, when appropriate, such as for determining distance between two time points in clear sky conditions and using the distance data to calibrate other sensors such as the odometer and/or LIDAR. In an embodiment, GNSS-based relative locations, based on, for example shared doppler and/or pseudorange measurements between vehicles, may be used to determine highly accurate distances between two vehicles, and when combined with vehicle information such as shape and model information and GNSS antenna location, may be used to calibrate, validate and/or affect the confidence level associated with information from LIDAR, camera, RADAR, SONAR and other distance estimation techniques. GNSS doppler measurements may also be utilized to determine linear motion and rotational motion of the vehicle or of the vehicle relative to another vehicle, which may be utilized in conjunction with gyro and/or magnetometer and other sensor systems to maintain calibration of those systems based upon measured location data. Relative GNSS positional data may also be combined with high confidence absolute locations from roadside devices 425, also known as roadside units or RSU, to determine high confidence absolute locations of the vehicle. Furthermore, relative GNSS positional data may be used during inclement weather that may obscure LIDAR and/or camera-based data sources to avoid other vehicles and to stay in the lane or other allocated road area. For example, using an RSU equipped with GNSS receiver and V2X capability, GNSS measurement data may be provided to the vehicle, which, if provided with an absolute location of the RSU, may be used to navigate the vehicle relative to a map, keeping the vehicle in lane and/or on the road, in spite of lack of visibility.

Radio detection and ranging-radar 153, uses transmitted radio waves that are reflected off of objects. The reflected radio waves are analyzed, based on the time taken for reflections to arrive and other signal characteristics of the reflected waves to determine the location of nearby objects. Radar 153 may be utilized to detect the location of nearby cars, roadside objects (signs, other vehicles, pedestrians, etc.) and will generally enable detection of objects even if there is obscuring weather such as snow, rail or hail. Thus, radar 153 may be used to complement LIDAR 150 systems and camera 135 systems in providing ranging information to other objects by providing ranging and distance measurements and information when visual-based systems typically fail. Furthermore, radar 153 may be utilized to calibrate and/or sanity check other systems such as LIDAR 150 and camera 135. Ranging measurements from radar 153 may be utilized to determine/measure stopping distance at current speed, acceleration, maneuverability at current speed and/or turning radius at current speed and/or a measure of maneuverability at current speed. In some systems, ground penetrating radar may also be used to track road surfaces via, for example, RADAR-reflective markers on the road surface or terrain features such as ditches.

The vehicle 100 may further contain multiple wireless transceivers including WAN, WLAN and/or PAN transceivers. In an embodiment, radio technologies that may support wireless communication link or links further comprise Wireless local area network (e.g., WLAN, e.g., IEEE 802.11), Bluetooth (BT) and/or ZigBee.

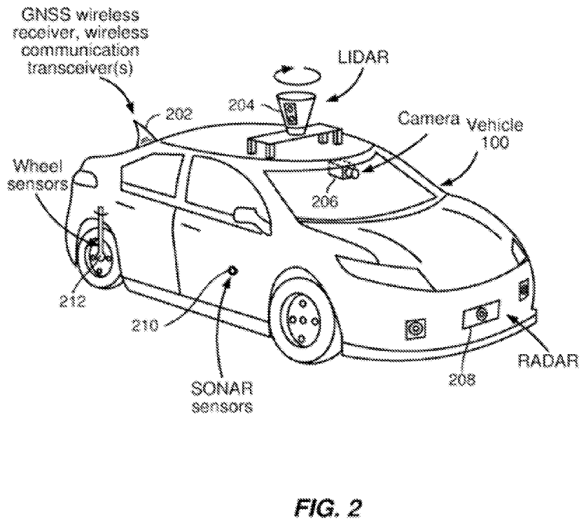

FIG. 2 illustrates a view of a vehicle configured with example sensor and communications components and/or systems. As shown in FIG. 2, a vehicle 100 may have, for example, camera(s) such as rear view mirror-mounted camera 206, front fender-mounted camera (not shown), side mirror-mounted camera (not shown) and a rear camera (not shown, but typically on the trunk, hatch or rear bumper). Vehicle 100 may also have a LIDAR subsystem 204, for detecting objects and measuring distances to those objects; LIDAR SYSTEM 204 is often roof-mounted, however, if there are multiple LIDAR units 204, they may be oriented around the front, rear and sides of the vehicle. Vehicle 100 may have other various location-related systems such as a GNSS receiver 170 (typically located in the shark fin unit on the rear of the roof), various wireless transceivers (such as WAN, WLAN, V2X; typically but not necessarily located in the shark fin) 202, RADAR system 208 (typically in the front bumper), and SONAR 210 (typically located on both sides of the vehicle, if present). Various wheel 212 and drive train sensors may also be present, such as tire pressure sensors, accelerometers, gyros, and wheel rotation detection and/or counters. It is realized that this list is not intended to be limiting and that FIG. 2 is intended to provide exemple locations of various sensors in an embodiment of vehicle 100. In addition, further detail in regard to particular sensors is described relative to FIG. 1.

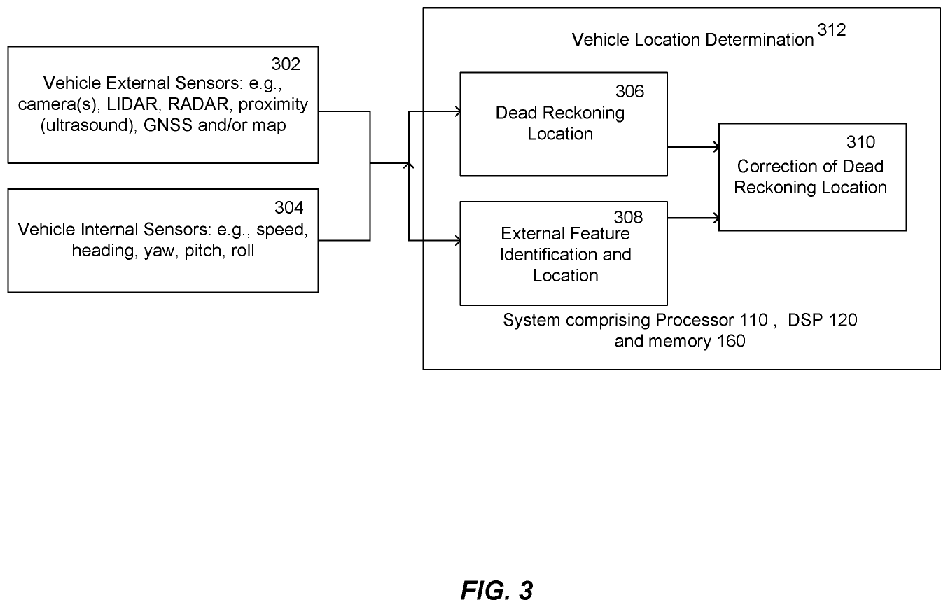

Referring to FIG. 3, a functional block level diagram of an example vehicle that determines its location by dead reckoning, and corrects for error in the dead reckoning location based on external feature measurements is shown. Vehicle 100 may receive vehicle information from vehicle external sensors 302 and vehicle internal sensors 304. The received vehicle sensor information may then be processed in Vehicle Location Determination module 312. The Vehicle Location Determination module 312, which may include one or more processors executing code, may further include modules, such as an External Feature Identification and Location Measurements Module 308, as well as a Current Dead Reckoning Location Module 306. Based on the location measurements of the identified external features, the dead reckoning location of the vehicle may be corrected 310.

Vehicle external sensors 302 may include, without limitation, cameras 206, LIDAR system 204, radar system 208, proximity sensors, rain sensors, weather sensors, GNSS receivers 170 and received data used with the sensors such as map data, environmental data, location, route and/or other vehicle or external feature information (see also FIGS. 1 and 2, and accompanying text). Vehicle internal sensors 304 may include: wheel sensors 212 such as tire pressure sensors, brake pad sensors, brake status sensors, speedometers and other speed sensors; heading sensors and/or orientation sensors such as magnetometers and geomagnetic compasses; distance sensors such as odometers and wheel tic sensors; inertial sensors such as accelerometers and gyros as well as inertial positioning results using the above-mentioned sensors; and yaw, pitch and/or roll sensors as may be determined individually or as determined using other sensor systems such as accelerometers, gyros and/or tilt sensors.

Both vehicle internal sensors 304 and vehicle external sensors 302 may have shared or dedicated processing capability. For example, a sensor system or subsystem may have a sensor processing core or cores that determines, based on measurements and other inputs from accelerometers, gyros, magnetometers and/or other sensing systems, car status values such as yaw, pitch, roll, heading, speed, acceleration capability and/or distance, and/or stopping distance. The different sensing systems may communicate with each other to determine measurement values. The car status values derived from measurements from internal and external sensors may be further combined with car status values and/or measurements from other sensor systems using a general or applications processor. In an embodiment, the sensors may be segregated into related systems, for example, LIDAR, radar, motion, wheel systems, etc., operated by dedicated core processing for raw results to output car status values from each core that are combined and interpreted to derive combined car status values, including capability data elements and status data elements, that may be used to control or otherwise affect car operation.

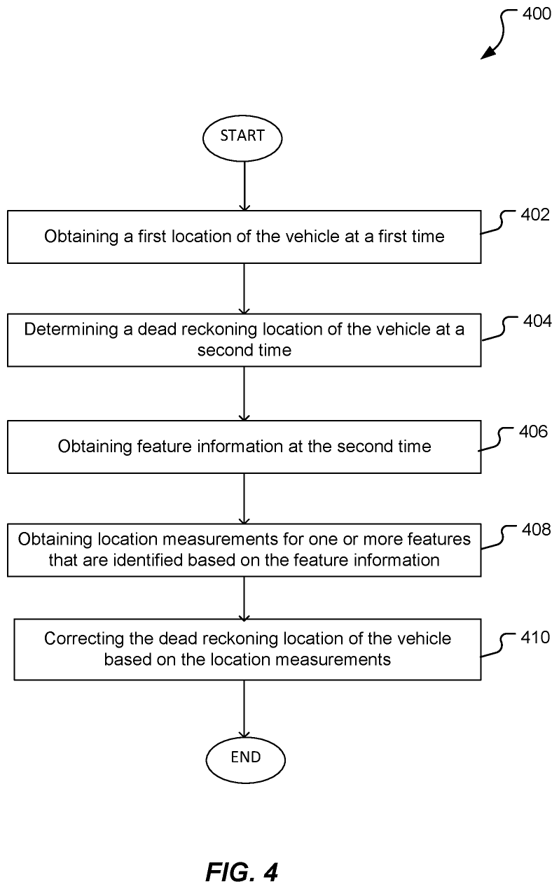

Referring to FIG. 4, with further reference to FIG. 1-3, an example method 400 for determining a dead reckoning location of a vehicle, and correcting associated errors is shown. The method 400 is, however, an example and not limiting. The method 400 may be altered, e.g., by having single stages split into multiple stages.

At stage 402, the method includes obtaining a first location of the vehicle at a first time. The GNSS receiver 170 and the processor 110 are a means for obtaining the first location. In an example, the processor 110 and the accelerometers, gyros, and magnetometers 140 may be a means for obtaining the first location. For example, the first location may be, without limitation, provided by utilizing GPS/GNSS, or may be a previously determined dead reckoning location.

At stage 404, the method includes determining a dead reckoning location of the vehicle at a second time. The Dead Reckoning Location Module 306 is a means for determining the dead reckoning location. In an example, the Dead Reckoning Location Module 306 may be configured to receive various measurements from the Vehicle Internal Sensors 304 and Vehicle External Sensors 304 to determine a dead reckoning location at a second time. Dead Reckoning or DR as it is usually referred, is the process by which a current position is calculated based on a previously obtained position. Generally, the dead reckoning location of the vehicle at the second time may be determined by advancing the first location based on sensor information providing, without limitation, heading, speed, and time, as known in the art. For example, the vehicle 100 may be equipped with sensors 145 and corresponding vehicle dimensions, such as wheel circumference measurements, and may be configured to record wheel rotations and steering direction. Other sensors such as one or more inertial sensors (e.g., accelerometer, gyroscope, solid state compass) may also be used.

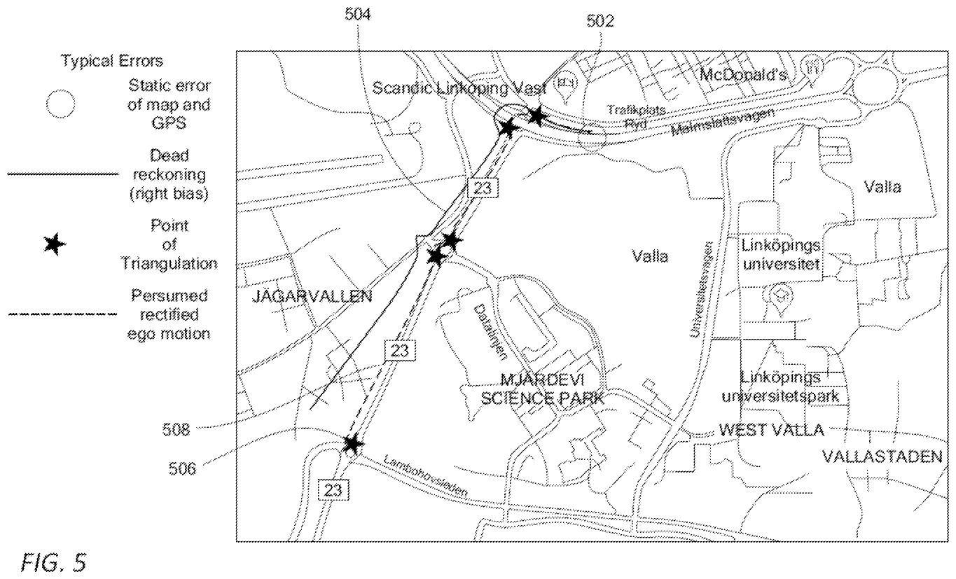

Error may accumulate based on sensor instability or other non-linearities associated with the sensor input. In an example, referring to FIG. 5, error that may result when performing dead reckoning (DR) are shown. A first location 502 determined at stage 402 may without limitation, be obtained via the GNSS receiver 170, which may include some amount of error (e.g., an uncertainty value). As a result, a subsequent dead reckoning (DR) estimate may also include the initial error, as well as other accumulated sensor error. For example, the sensor information provided to the Dead Reckoning Location Module 306 may be slightly inaccurate, and may result in a right or left bias, as shown in path 504, and/or an erroneous distance. The corresponding DR location of the vehicle determined at stage 404 may include such errors.

Referring back to FIG. 4, the error in the dead reckoning position estimate may be corrected. To accomplish this, initially, at stage 406, the method includes obtaining feature information at the second time. The processor 110 and the wireless transceiver(s) 130 are a means for obtaining feature information at a second time. In an example, obtaining the feature information may include retrieving from memory 160 or other sources those features in the surrounding area that may be identifiable via the various vehicle sensors. These features may include, without limitation, an intersection, a crosswalk, a geographic landmark, a building, a width of a road, a road sign, the width of the road, a traffic light, a telephone post, highway exits, and/or a lamp post. The feature information may include records for at least some of the vehicle's surrounding objects, which may be included, for example, in a digital map or database. These records may include relative positional attributes in addition to traditional absolute positions. The records may also include identification data sufficient to identify the feature in the sensor data received. A GNSS receiver 170 and/or wireless transceiver 130 may be utilized to obtain the feature information. The vehicle 100 may be configured to provide location coordinates (e.g., lat./long.) to a third party service provider to obtain information regarding those features located in an area proximate to a coarse position of the vehicle. The coarse position of the vehicle 100 may be based on the dead reckoning location determined at the second time, and/or on other positioning techniques such as, for example, GPS. The extent of the surrounding area of the vehicle 100 to be searched (for features) may be based on a configuration option or other application criteria (e.g., a position uncertainty value) and may encompass a range of, without limitation, 100, 200, 500, 1000 yards around the course location of the vehicle 100. In an example, the vehicle 100 may have feature/coarse map information stored in local memory 160, and the vehicle 100 may parse the feature/coarse map information to determine those features proximate to the vehicle 100.

At stage 408, the method includes obtaining location measurements for one or more features that are identified based on the feature information. The External Feature Identification and Location Module 308 is a means for obtaining the location measurements. Stage 408 may include obtaining sensor information from the one or more sensors 302 and 303 (described above). The sensor information obtained is provided to the External Feature Identification and Location Module 308, whereupon various recognition techniques known in the art may be utilized to identify one or more features in the surrounding area. For example, a vision/optical sensor(s) (e.g., a camera 135) may be configured to obtain images proximate to the vehicle 100. A recognition process(es) may be performed on the obtained images using, in part, the feature information obtained in stage 406, whereby one or more feature(s) is identified. Once a feature(s) is identified, a radar or LIDAR system (or other sensor) may obtain a range and/or a bearing to the identified feature relative to the vehicle 100. Other sensors may be configured to provide other information. The sensor information may be obtained on demand or periodically, such as based on a sensor duty cycle. The one or more location measurements may include, without limitation, temporal separation measurements, in addition to spatial separation measurements. Range sensors, such as included in the vehicle external sensors 302, may be used in conjunction with inertial measurement devices (e.g., gyroscopes, accelerometers 140) to determine a bearing and elevation to an object based on the coordinate system and the orientation of the range sensor.

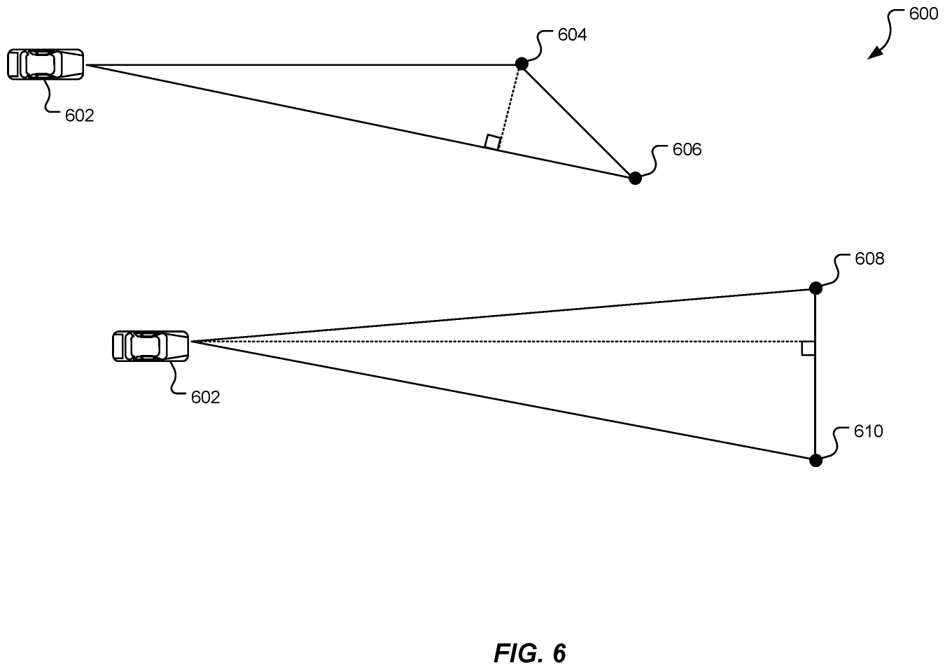

At stage 410, the method includes correcting the dead reckoning location of the vehicle based on the location measurements, as illustratively shown in path 508, depicted in FIG. 5. The Correction of Dead Reckoning Location Module 310 is a means for correcting the dead reckoning location. The known locations of the identifiable feature(s), along with the sensed range and/or bearing to the identifiable features may be used to improve the accuracy of the dead reckoning location. For example, depending on the number of features identified and their known absolute locations, and using spatial separation (e.g., range and/or bearing) and/or temporal separation, a corrected location of the vehicle 100 may be determined, using location techniques known in the art. Illustratively, triangulation, as shown in FIG. 6, and/or trilateralization may be used to determine the corrected location of the vehicle.

Referring to FIG. 6, diagram 600 of example triangulation based on feature location measurements to determine a location of a vehicle is shown. The diagram 600 includes a vehicle 602 and a plurality of roadside features including a first feature 604, a second feature 606, a third feature 608, and a fourth feature 610. The vehicle 602 may include some or all of the features of the vehicle 100, and the vehicle 100 may be an example of the vehicle 602. The features 604, 606, 608, 610 may be one or more of an intersection, a crosswalk, a geographic landmark, a building, a width of a road, a road sign, the width of the road, a traffic light, a telephone post, highway exits, a lamp post, or other objects which may be detected by one or more of the vehicle external sensors 302. Feature information such as respective locations and other distinguishing aspects which may be detected by the external sensors 302 (e.g., text, expected return signal, chromatic configurations, etc.) may be provided at stage 406, and the external feature identification and location module 308 may be configured to utilize the sensor input to determine the locations of the features. The vehicle location determination module 312 may be configured to utilize the spatial separation and relative positions of the features to perform triangulation or multilateration computations. In a first example, the vehicle 602 may utilize the locations and respective ranges to the first feature 604 and the second feature 606 to determine a first position estimate. In a second example, the vehicle 602 may utilize the locations and respective ranges to the third feature 608 and the fourth feature 610 to determine a second position estimate. Temporal separation between feature detection and range measurement may also be used. For example, longitudinal and lateral corrections may be separated by projections on the X-Y axis. In this way, a single feature may be used to determine a position estimate for a vehicle (e.g., a running fix). Other electronic measurement techniques such as doppler, angle of departure (of transmitted signals), angle of arrival (of reflected signals), and signal strength information may be used for determining a position of a vehicle.

Referring back to FIG. 5, as the vehicle 100 continues to move, the first location may be set to the corrected dead reckoning location of the vehicle, and the dead reckoning procedure may be repeated. More particularly, a second dead reckoning position may be determined at a third time, along with obtaining second feature information. Second location measurements for one or more features that are identifiable based on the second feature information are obtained, and the dead reckoning location of the vehicle is corrected based on the second location measurements. The triangulation/multilateration techniques described in FIG. 6 may be applied to correct the location estimate of the vehicle 100 at various correction points 506 to determine the location measurements and correct the dead reckoning location of the vehicle at stage 410.

Obtaining location measurements for one or more features may include sensor fusion. By using sensor fusion, inputs from a plurality of sources/sensors, such as, a GPS/map, a LIDAR sensor(s), a radar sensor(s) and/or a camera(s) can be combined using software algorithms, as known in the art, to determine location measurements. The resulting measurement is more accurate because it balances the strengths of the different sensors. Each type of sensor has various strengths and/or weaknesses. Radars accurately determine distance and speed—even in challenging weather conditions—but can't read street signs or “see” the color of a stoplight. Cameras can read signs or classifying objects, however, they can easily be blinded by weather conditions, dirt etc. LIDAR may accurately detect objects, but they generally don't have the range or affordability of cameras or radar. A vehicle may also use sensor fusion to fuse information from multiple sensors of the same type as well, to take, for example, advantage of partially overlapping fields of view.

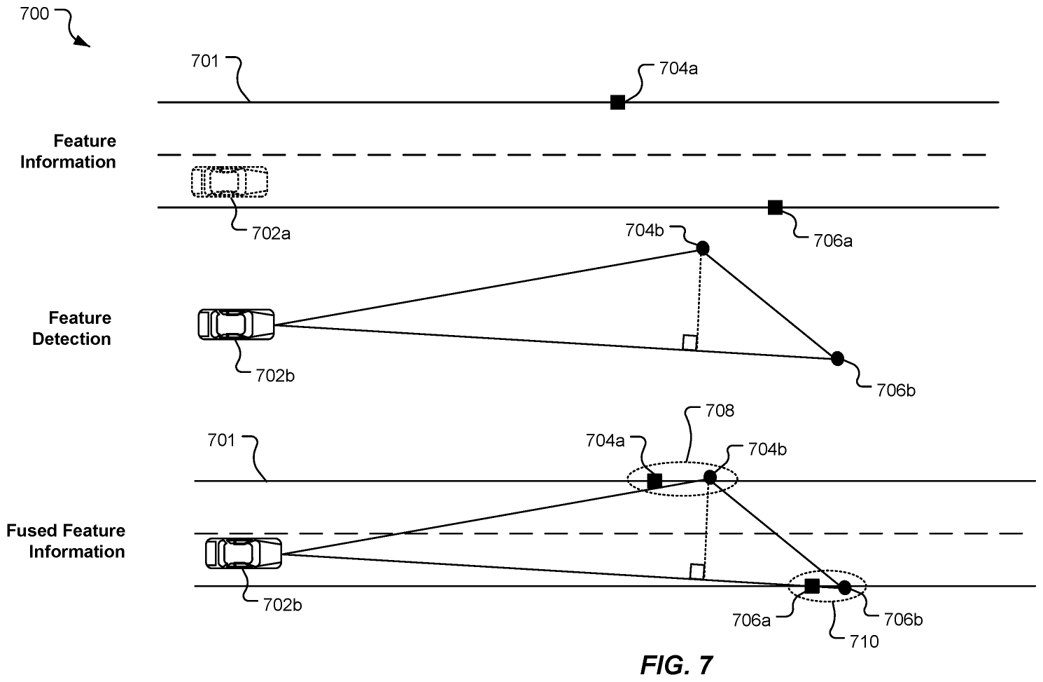

Referring to FIG. 7, a diagram 700 of example of map and sensor information fusion is shown. The diagram 700 includes a road segment 701 with a plurality of features and corresponding locations based on map information and sensor measurements. In an example, a vehicle may be at an assumed position 702a and may receive feature information including a first map location 704a of a first feature, and a second map location 706a of a second feature. A measured position 702b of the vehicle may be based on measurements of the first feature and the second features. In an example, the measured position 702b may also be based on external measurements, such as a GNSS or other terrestrial measurements. As a result of the computation of the measured position 702b and the respective measurements to the first and second features, the first feature may be determined to be at a first measured location 704b, and the second feature may be determined to be at a second measured location 706b. The vehicle may be configured to generate fused locations for the features based on the respective map locations 704a, 706a and the measured locations 704b, 706b. For example, a first fused location 708 may be based on the average of the first map location 704a and the first measured location 704b, and a second fused location 710 may be based on the average of the second map location 706a and the second measured location 706b. In an example, the average location may be determined based on averaging the respective coordinate measurements (e.g., lat/long/alt) for each feature and each respective measurement and map data. While FIG. 7 illustrates one measurement for each of the features, additional measurements for each feature based on different sensors may also be obtained. In an example, correcting the DR location at stage 410 may be based on applying the measurements obtained by the vehicle (e.g., measured range, angle of arrival, etc.) to the respective fused locations of the features.

In an example, the measured location 702b of the vehicle may be based on machine learning methods or algorithms. For example, training data including detection of known features may be associated with known locations. Range measurements and other signal analysis (e.g., reflected signal strengths, the channel response at a location, etc.) may be also be used as training data that is associated with known locations of the vehicle. In an example, correcting the error in the dead reckoning may also be realized by compiling correction data pertaining to the location of the vehicle over time. Other machine learning, artificial intelligence and/or neural network methods and algorithms may be used with the compiled correction data to predict errors in dead reckoning position estimates and determine a current location of the vehicle.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Implementation examples are described in the following numbered clauses:

Clause 1. A method of determining location of a vehicle, the method comprising: obtaining a first location of the vehicle at a first time; determining a dead reckoning location of the vehicle at a second time; obtaining feature information at the second time; obtaining location measurements for one or more features that are identifiable based on the feature information; and correcting the dead reckoning location of the vehicle based on the location measurements.

Clause 2. The method according to clause 1, further comprising: setting the first location to the corrected dead reckoning location; determining a second dead reckoning location of the vehicle at a third time; obtaining second feature information at the third time; obtaining second location measurements for one or more features that are identifiable based on the second feature information; and correcting the second dead reckoning location of the vehicle based on the second location measurements.

Clause 3. The method according to clause 1, wherein obtaining the first location includes obtaining a location computed by a satellite position system.

Clause 4. The method according to clause 1, wherein the vehicle includes one or more sensors, and wherein obtaining location measurements for the one or more features includes obtaining sensor information from the one or more sensors.

Clause 5. The method according to clause 4, wherein the one or more sensors includes a LIDAR device, a camera device, a radar device, or combinations thereof.

Clause 6. The method according to clause 1, where the one or more features includes an intersection, a crosswalk, a geographic landmark, a building, width of a road, a road sign, a traffic light, a telephone post, a lamp post , or combinations thereof.

Clause 7. The method according to clause 1, wherein obtaining feature information further comprises obtaining a range and/or bearing of at least one of the one or more features relative to the vehicle.

Clause 8. The method according to clause 1, wherein correcting the dead reckoning location of the vehicle includes triangulation and/or trilateration.

Clause 9. The method according to clause 1, wherein obtaining location measurements for one or more features includes sensor fusion.

Clause 10. The method according to clause 1, further comprising: compiling correction data pertaining to the location of the vehicle over time; using statistical bias and/or a neural network to predict error in the dead reckoning; and using the predicted error in dead reckoning to correct a current location of the vehicle.

Clause 11. A system for determining location of a vehicle, the system comprising: memory; at least one processor communicatively coupled to the memory, and configured to: obtain a first location of the vehicle at a first time; determine a dead reckoning location of the vehicle at a second time; obtain feature information at the second time; obtain location measurements for one or more features that are identifiable based on the feature information; and correct the dead reckoning location of the vehicle based on the location measurements.

Clause 12. The system according to clause 11, wherein the at least one processor is further configured to: set the first location to the corrected dead reckoning location; determine a second dead reckoning location of the vehicle at a third time; obtain second feature information at the third time; obtain second location measurements for one or more features that are identifiable based on the second feature information; and correct the second dead reckoning location of the vehicle based on the second location measurements.

Clause 13. The system according to clause 11, wherein the at least one processor is configured to obtain the first location utilizing, in part, a location computed by a satellite position system.

Clause 14. The system according to clause 11, wherein the vehicle includes one or more sensors, and wherein the at least one processor is configured to obtain the first location utilizing sensor information from the one or more sensors.

Clause 15. The system according to clause 14, wherein the one or more sensors includes a LIDAR device, a camera device, a radar device, or combinations thereof.

Clause 16. The system according to clause 11, where the one or more features includes an intersection, a crosswalk, a geographic landmark, a building, width of a road, a road sign, a traffic light, a telephone post, a lamp post, or combinations thereof.

Clause 17. The system according to clause 11, wherein the at least one processor is configured to obtain feature information including a range and/or bearing of at least one of the one or more features relative to the vehicle.

Clause 18. The system according to clause 11, wherein the at least one processor is configured to correct the dead reckoning location using, at least in part, triangulation and/or trilateration.

Clause 19. The system according to clause 11, wherein that at least one processor is configured to obtain location measurements for one or more features using, at least in part, sensor fusion.

Clause 20. The system according to clause 11, wherein the at least one processor is further configured to: compile correction data pertaining to the location of the vehicle over time; use statistical bias and/or a neural network to predict error in the dead reckoning; and use the predicted error in dead reckoning to correct a current location of the vehicle.

Clause 21. A system for determining location of a vehicle, the system comprising: means for obtaining a first location of the vehicle at a first time; means for determining a dead reckoning location of the vehicle at a second time; means for obtaining feature information at the second time; means for obtaining location measurements for one or more features that are identifiable based on the feature information; and means for correcting the dead reckoning location of the vehicle based on the location measurements.

Clause 22. The system according to clause 21, further comprising: means for setting the first location to the corrected dead reckoning location; means for determining a second dead reckoning location of the vehicle at a third time; means for obtaining second feature information at the third time; means for obtaining second location measurements for one or more features that are identifiable based on the second feature information; and means for correcting the second dead reckoning location of the vehicle based on the second location measurements.

Clause 23. The system according to clause 21, wherein the means for obtaining the first location includes obtaining a location computed by a satellite position system.

Clause 24. The system according to clause 21, wherein the vehicle includes one or more sensors, and wherein obtaining location measurements for the one or more features includes means for obtaining sensor information from the one or more sensors.

Clause 25. The system according to clause 24, wherein the one or more sensors includes a LIDAR device, a camera device, a radar device, or combinations thereof.

Clause 26. The system according to clause 21, where the one or more features includes an intersection, a crosswalk, a geographic landmark, a building, width of a road, a road sign, a traffic light, a telephone post, a lamp post, or combinations thereof.

Clause 27. The system according to clause 21, wherein the means for obtaining feature information includes obtaining a range and/or bearing of at least one of the one or more features relative to the vehicle.

Clause 28. The system according to clause 21, wherein the means for correcting the dead reckoning location of the vehicle includes triangulation and/or trilateration.

Clause 29. The system according to clause 21, wherein the means for obtaining location measurements for one or more features includes sensor fusion.

Clause 30. The system according to clause 21, further comprising: means for compiling correction data pertaining to the location of the vehicle over time; means for using statistical bias and/or a neural network to predict error in the dead reckoning; and means for using the predicted error in dead reckoning to correct a current location of the vehicle.

Clause 31. A non-transitory processor-readable storage medium comprising processor-readable instructions configured to cause one or more processors to determine a location of a vehicle, comprising: code for obtaining a first location of the vehicle at a first time; code for determining a dead reckoning location of the vehicle at a second time; code for obtaining feature information at the second time; code for obtaining location measurements for one or more features that are identifiable based on the feature information; and code for correcting the dead reckoning location of the vehicle based on the location measurements.

Clause 32. The non-transitory processor-readable storage medium according to clause 31, further comprising: code for setting the first location to the corrected dead reckoning location; code for determining a second dead reckoning location of the vehicle at a third time; code for obtaining second feature information at the third time; code for obtaining location measurements for one or more features that are identifiable based on the second feature information; and code for correcting the second dead reckoning location of the vehicle based on of the second location measurements.

Clause 33. The non-transitory processor-readable storage medium according to clause 31, wherein the code for obtaining the first location includes code for obtaining a location computed by a satellite position system.

Clause 34. The non-transitory processor-readable storage medium according to clause 31, wherein the vehicle includes one or more sensors, and wherein the code for obtaining location measurements for the one or more features includes code for obtaining sensor information from the one or more sensors.

Clause 35. The non-transitory processor-readable storage medium according to clause 34, wherein the one or more sensors includes a LIDAR device, a camera device, a radar device or combinations thereof.

Clause 36. The non-transitory processor-readable storage medium according to clause 31, where the one or more features includes an intersection, a crosswalk, a geographic landmark, a building, width of a road, a road sign, a traffic light, a telephone post, a lamp post or combinations thereof.

Clause 37. The non-transitory processor-readable storage medium according to clause 31, wherein the code for obtaining feature information further includes code for obtaining a range and/or bearing of at least one of the one or more features relative to the vehicle.

Clause 38. The non-transitory processor-readable storage medium according to clause 31, wherein the code for correcting the dead reckoning location of the vehicle includes code for performing triangulation and/or trilateration.

Clause 39. The non-transitory processor-readable storage medium according to clause 31, wherein the code for obtaining location measurements for one or more features includes code for performing sensor fusion.

Clause 40. The non-transitory processor-readable storage medium according to clause 31, further comprising: code for compiling correction data pertaining to the location of the vehicle over time; code for using statistical bias and/or a neural network to predict error in the dead reckoning; and code for using the predicted error in dead reckoning to correct a current location of the vehicle.

What is claimed is:

1. A method of determining location of a vehicle, the method comprising:
obtaining a first location of the vehicle at a first time;
determining a dead reckoning location of the vehicle at a second time;
obtaining feature information at the second time;
obtaining location measurements for one or more features that are identifiable based on the feature information; and
correcting the dead reckoning location of the vehicle based on the location measurements.

2. The method according to claim 1, further comprising:
setting the first location to the corrected dead reckoning location;
determining a second dead reckoning location of the vehicle at a third time;
obtaining second feature information at the third time;
obtaining second location measurements for one or more features that are identifiable based on the second feature information; and
correcting the second dead reckoning location of the vehicle based on the second location measurements.

3. The method according to claim 1, wherein obtaining the first location includes obtaining a location computed by a satellite position system.

4. The method according to claim 1, wherein the vehicle includes one or more sensors, and wherein obtaining location measurements for the one or more features includes obtaining sensor information from the one or more sensors.

5. The method according to claim 4, wherein the one or more sensors includes a LIDAR device, a camera device, a radar device, or combinations thereof.

6. The method according to claim 1, where the one or more features includes an intersection, a crosswalk, a geographic landmark, a building, width of a road, a road sign, a traffic light, a telephone post, a lamp post , or combinations thereof.

7. The method according to claim 1, wherein obtaining the feature information further comprises obtaining a range or bearing of at least one of the one or more features relative to the vehicle.

8. The method according to claim 1, wherein correcting the dead reckoning location of the vehicle includes triangulation or trilateration.

9. The method according to claim 1, wherein obtaining location measurements for one or more features includes sensor fusion.

10. The method according to claim 1, further comprising:
compiling correction data pertaining to a location of the vehicle over time;
using statistical bias or a neural network to predict error in the dead reckoning; and
using the predicted error in dead reckoning to correct a current location of the vehicle.

11. A system for determining location of a vehicle, the system comprising:
memory;
at least one processor communicatively coupled to the memory, and configured to:
obtain a first location of the vehicle at a first time;
determine a dead reckoning location of the vehicle at a second time;
obtain feature information at the second time;
obtain location measurements for one or more features that are identifiable based on the feature information; and
correct the dead reckoning location of the vehicle based on the location measurements.

12. The system according to claim 11, wherein the at least one processor is further configured to:
set the first location to the corrected dead reckoning location;
determine a second dead reckoning location of the vehicle at a third time;
obtain second feature information at the third time;
obtain second location measurements for one or more features that are identifiable based on the second feature information; and
correct the second dead reckoning location of the vehicle based on the second location measurements.

13. The system according to claim 11, wherein the at least one processor is configured to obtain the first location utilizing, in part, a location computed by a satellite position system.

14. The system according to claim 11, wherein the vehicle includes one or more sensors, and wherein the at least one processor is configured to obtain the first location utilizing sensor information from the one or more sensors.

15. The system according to claim 14, wherein the one or more sensors includes a LIDAR device, a camera device, a radar device, or combinations thereof.

16. The system according to claim 11, where the one or more features includes an intersection, a crosswalk, a geographic landmark, a building, width of a road, a road sign, a traffic light, a telephone post, a lamp post, or combinations thereof.

17. The system according to claim 11, wherein the at least one processor is configured to obtain feature information including a range or bearing of at least one of the one or more features relative to the vehicle.

18. The system according to claim 11, wherein the at least one processor is configured to correct the dead reckoning location using, at least in part, triangulation or trilateration.

19. The system according to claim 11, wherein that at least one processor is configured to obtain location measurements for one or more features using, at least in part, sensor fusion.

20. The system according to claim 11, wherein the at least one processor is further configured to:
compile correction data pertaining to the location of the vehicle over time;
use statistical bias or a neural network to predict error in the dead reckoning; and
use the predicted error in dead reckoning to correct a current location of the vehicle.

21. A system for determining location of a vehicle, the system comprising:
means for obtaining a first location of the vehicle at a first time;
means for determining a dead reckoning location of the vehicle at a second time;
means for obtaining feature information at the second time;
means for obtaining location measurements for one or more features that are identifiable based on the feature information; and
means for correcting the dead reckoning location of the vehicle based on the location measurements.

22. The system according to claim 21, further comprising:
means for setting the first location to the corrected dead reckoning location;
means for determining a second dead reckoning location of the vehicle at a third time;
means for obtaining second feature information at the third time;
means for obtaining second location measurements for one or more features that are identifiable based on the second feature information; and
means for correcting the second dead reckoning location of the vehicle based on the second location measurements.

23. The system according to claim 21, wherein the vehicle includes one or more sensors, and wherein obtaining location measurements for the one or more features includes means for obtaining sensor information from the one or more sensors.

24. The system according to claim 21, where the one or more features includes an intersection, a crosswalk, a geographic landmark, a building, width of a road, a road sign, a traffic light, a telephone post, a lamp post, or combinations thereof.

25. The system according to claim 21, wherein the means for obtaining feature information includes obtaining a range or bearing of at least one of the one or more features relative to the vehicle.

26. The system according to claim 21, wherein the means for correcting the dead reckoning location of the vehicle includes triangulation or trilateration.

27. The system according to claim 21, wherein the means for obtaining location measurements for one or more features includes sensor fusion.

28. The system according to claim 21, further comprising:
means for compiling correction data pertaining to the location of the vehicle over time;
means for using statistical bias or a neural network to predict error in the dead reckoning; and
means for using the predicted error in dead reckoning to correct a current location of the vehicle.

29. A non-transitory processor-readable storage medium comprising processor-readable instructions configured to cause one or more processors to determine a location of a vehicle, comprising:
code for obtaining a first location of the vehicle at a first time;
code for determining a dead reckoning location of the vehicle at a second time;
code for obtaining feature information at the second time;
code for obtaining location measurements for one or more features that are identifiable based on the feature information; and
code for correcting the dead reckoning location of the vehicle based on the location measurements.

30. The non-transitory processor-readable storage medium according to claim 29, further comprising:
code for setting the first location to the corrected dead reckoning location;
code for determining a second dead reckoning location of the vehicle at a third time;
code for obtaining second feature information at the third time;
code for obtaining location measurements for one or more features that are identifiable based on the second feature information; and
code for correcting the second dead reckoning location of the vehicle based on of the second location measurements.
